(19) United States
(12) Patent Application Publication
(10) Pub. No.: US 2014/0305350 A1
(43) Pub. Date: Oct. 16, 2014

(54) Robber Trapping Door

(71) Applicant: Pierre-Marie Grondin, Beauceville (CA)

(72) Inventor: Pierre-Marie Grondin, Beauceville (CA)

(21) Appl. No.: 13/859,821

(22) Filed: Apr. 10, 2013

(51) Int. Cl. E05G 5/02

(52) U.S. Cl. CPC E05G 5/02
USPC 109/8

(57) ABSTRACT

A robber trapping door has a locking assembly comes into function in order to lock the trapping door, it is comprised of a locking bar that extends so as to interfere with a triangular member, which locks the door from turning in one direction. To prevent the door from turning in the opposite direction, a pair of ratcheting means normally operate so as to also interfere with the triangular member. The ratcheting means work in a fashion similar to ratchets of the prior art, meaning that they will be movable when pushed in one particular direction but unmovable when pushed in any other directions by way of a biasing means, which brings them back to their original position.

### FIELD OF THE INVENTION

The present invention relates generally to doorways but more particularly to a door for trapping robbers.

### BACKGROUND OF THE INVENTION

Banks and other types of commerce are the victims of robbery. If the robber could be caught soon after he commits his act, that could increase the number of arrests.

### SUMMARY OF THE INVENTION

It is a main advantage of this invention to provide for a door system that catches robbers. Besides catching robbers, the invention can also be used as a deterrent.

In order to do so, the invention consists in a turnstile member adapted to be securely mounted to a floor surface, and including a rotatable axis member having a vertical length and a plurality of door panels having equal heights and are attached along respective vertical side portions to the axis member along a substantial portion of the length of the axis member. A plurality of partition members adapted to be securely mounted to the floor surface having equal heights that are less than the length of the axis member and greater than the height of the plurality of door panels, wherein the plurality of partition members surround the turnstile member in a circular configuration having two openings on opposite sides thereof adapted for a person to pass therethrough. A top panel member securely fastened to a top portion of each of the plurality of partition members, and including a passageway in a center portion thereof adapted to allow a top distal end of the axis member to pass therethrough, such that when the turnstile is rotated to a predetermined position, two of the plurality of door panels along with the partition members and the top panel member form an enclosed cell section adapted to trap a robber therein for apprehension; and a locking mechanism securely attached to a center top portion of the top panel member and mechanically connected to the top distal end of the axis member, and adapted such that a person can activate the locking mechanism, prevent the rotation of the turnstile member at the predetermined position, and lock it in place.

The plurality of door panels includes a locked swing section adapted to be unlocked and opened creating an opening to thereby facilitate deliveries.

The locking mechanism includes a tamper proof box covering the locking mechanism and is securely connected to the top panel member, thereby enclosing the locking mechanism and preventing unwarranted tampering of the locking mechanism.

The locking mechanism is adapted to be operated remotely, such that a person can activate the locking mechanism from a distance to trap a robber, and then release the locking mechanism once a law enforcement officer arrives to apprehend the robber.

The top distal end of the axis member includes a triangular shaped portion; and the locking mechanism includes a locking bar adapted to interfere with the rotational movement of the triangular shaped portion and thereby the turnstile.

The locking mechanism further includes a solenoid member adapted to push the locking bar into an interfering position with the triangular shaped portion of the axis member, and a pulling assembly that includes a rotating cam that pulls a chain member, which pulls the locking bar away from the interfering position, and wherein the cam is rotated by a catch member that is adapted to be moved by person authorized to release the locking mechanism.

The catch member includes a dial member that only rotates when a predetermined code is entered and accepted therein.

The locking mechanism further includes a pair of spring biased ratchet members adapted to also interfere with the triangular shaped portion, and adapted to ensure that the turnstile rotates in only one predetermined direction.

The locking mechanism further includes a solenoid that is adapted to push the locking bar into an interfering position with the triangular shaped portion of the axis member, and adapted such that the locking mechanism can be operated remotely.

The locking mechanism further includes a peg attached thereon, and the top distal end of the axis member further includes a spoked member having a plurality of resiliently deformable spokes radiating outwardly therefrom rotating along with the axis member and are adapted to hit the peg member and dampen the rotational movement of the turnstile.

The plurality of door panels includes a plate member adapted to be pushed by a person passing through the turnstile.

The robber trapping door includes at least one attachment bracket adapted to be attached between a partition member and the floor or an adjacent wall.

The robber trapping door further includes a motion detector.

The robber trapping door has the tamper proof box with all its locking systems is located at a time above and adjacent the cell and near an entrance to a building.

The robber trapping door has the unlocking system, using combinations always installed in the section adjacent the cell and proximal an entrance door.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIGS. 1a-c Exploded view, and detail views of the invention.

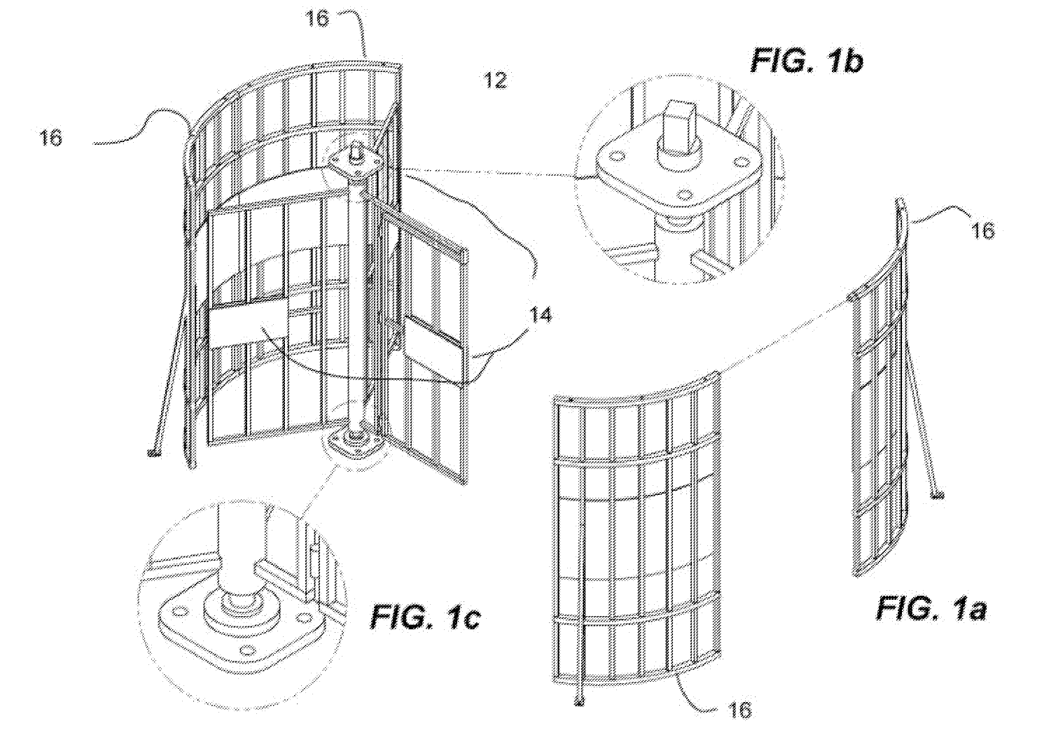

FIGS. 2a-b Top and side views of the locking assembly when in locked configuration.

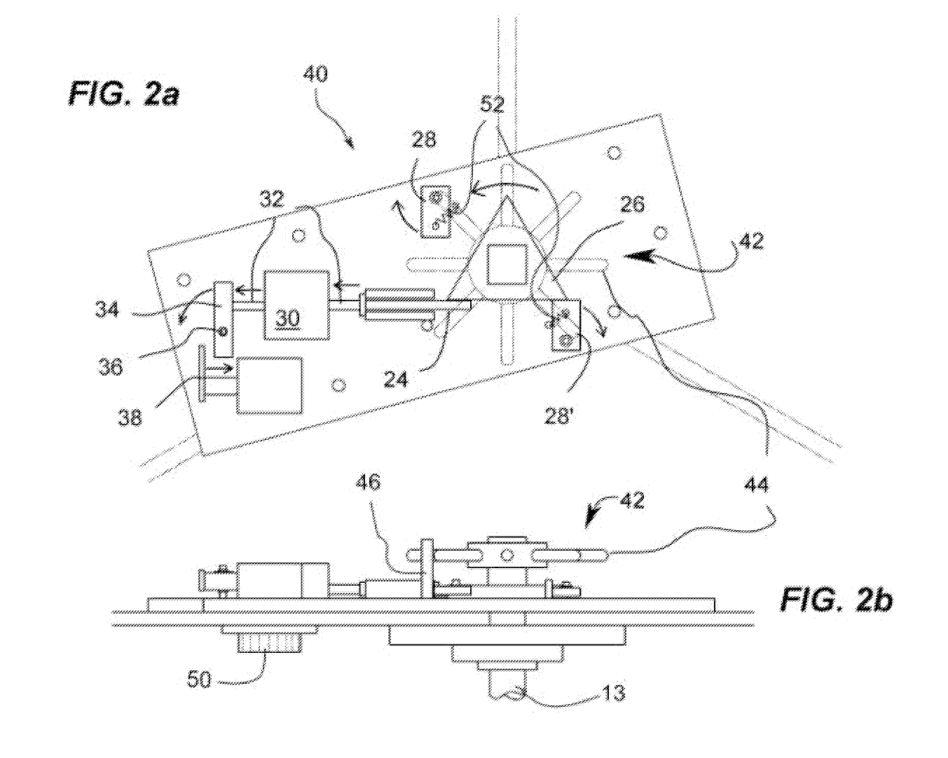

FIG. 3 Isometric view of the turnstile member.

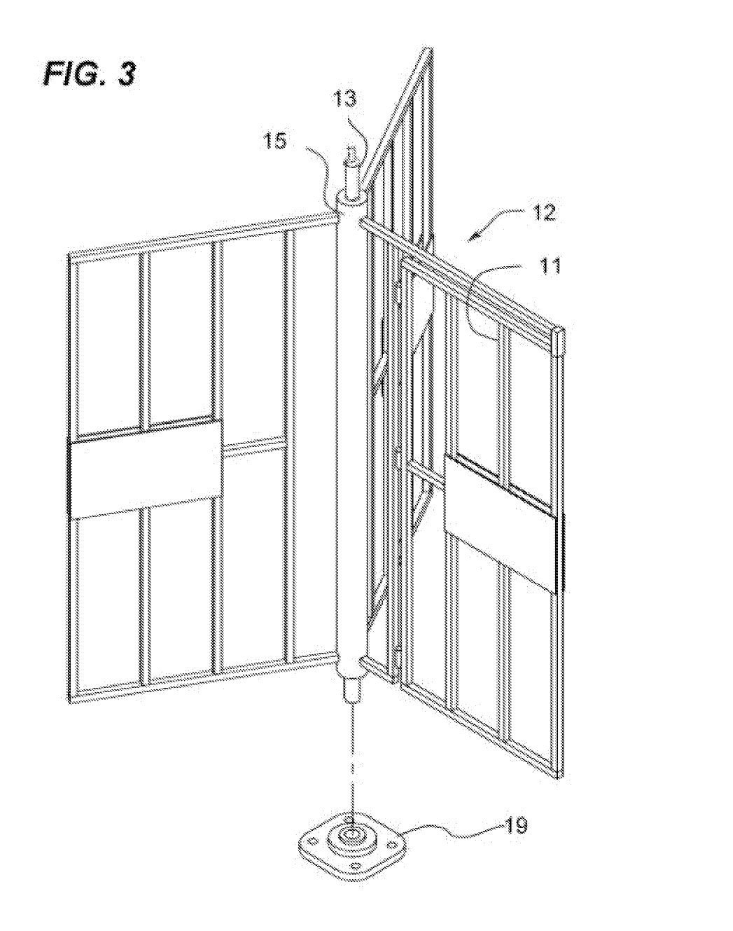

FIG. 4 Isometric view of the turnstile and partition members.

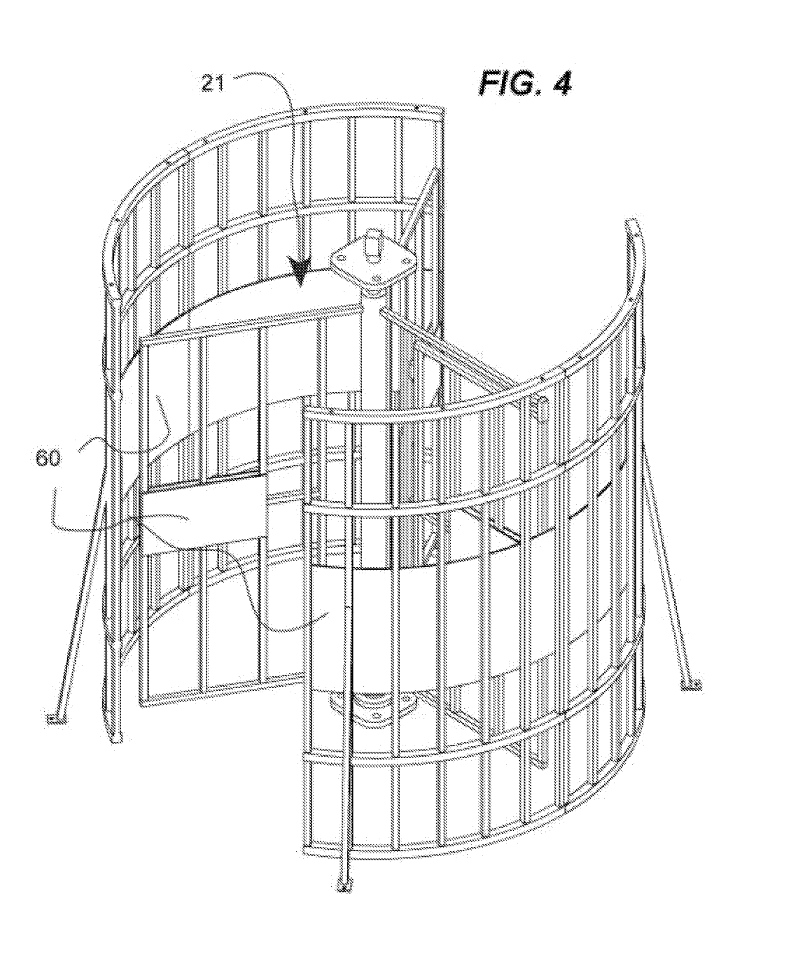

FIGS. 5a-b Isometric view of the invention and detail of the locking assembly.

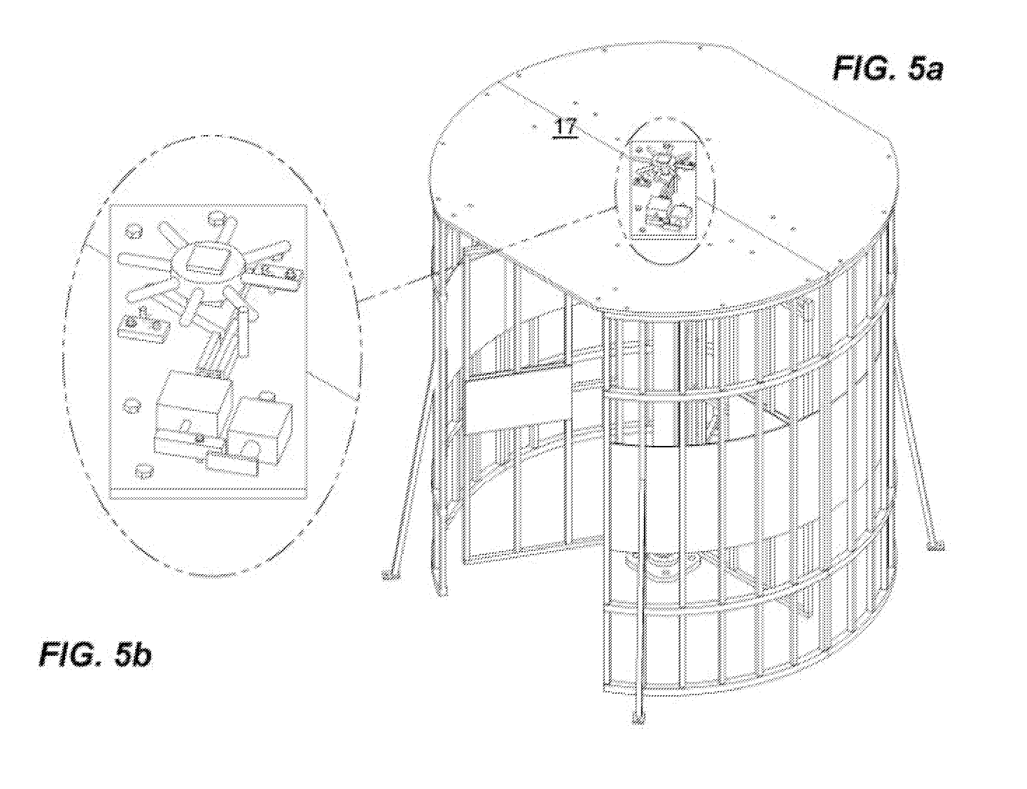

FIG. 6 Isometric view of the invention where the turnstile is positioned in trapping mode.

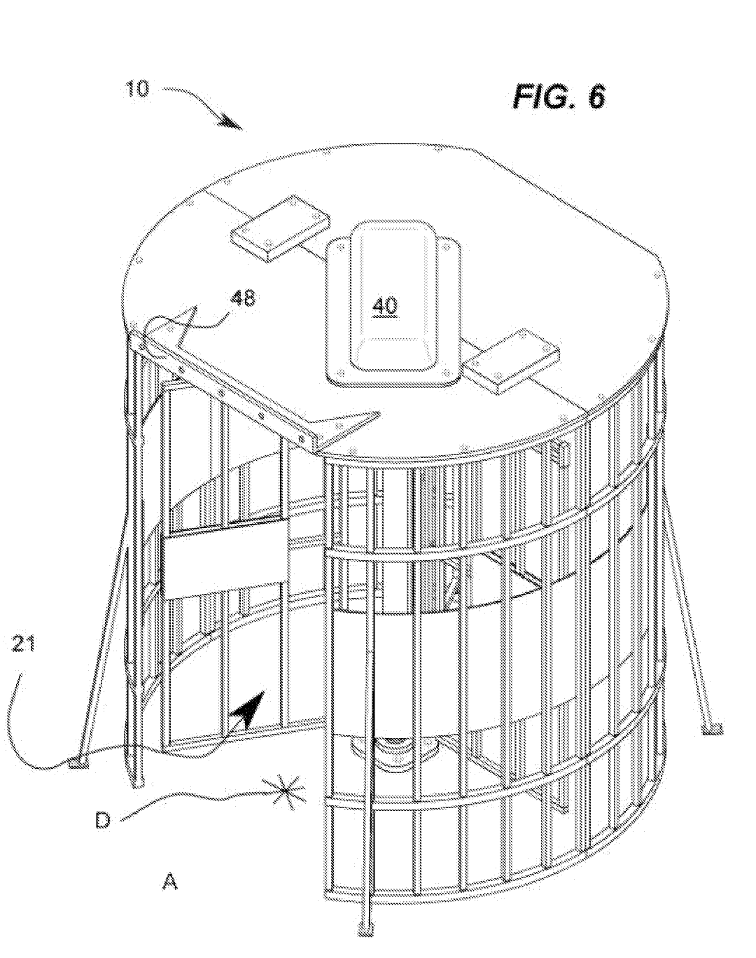

FIG. 7 Top view of the turnstile and partition members.

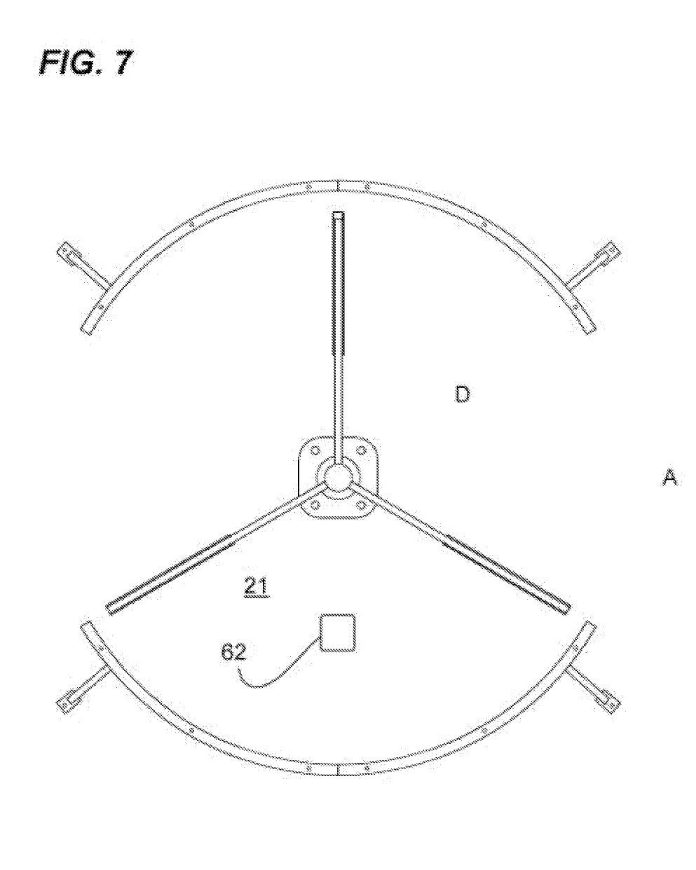

### DETAILED DESCRIPTION

A robber trapping door (10) has a turnstile member (12) consisting of three door panels (14) and four partition members (16). The partition members (16) are fixed and generally mechanically fastened to the floor so that only the turnstile member (12) is movable. The robber trapping door (10) is generally located close to the actual entry door (not shown), and has an attachment bracket (48) to attach to an existing wall (not shown). The turnstile member (12) is rotationally connected to a tamper proof box (40) by way of a turnstile connector (13) connecting with a turnstile axis (15). The turnstile axis (15) rests on a base (19) bolted onto the floor (not shown). The tamper proof box (40) with all its locking systems is located above and adjacent a cell (21) as well as in zone “D” close to the entrance door “A”

Top panel members (17) are fixedly attached to the partition members (16) so as to prevent any possible egress.

One of the three door panels (14) has a locked swing section (11) that opens so as to create an opening to facilitate deliveries.

In normal mode, the trapping door (10) operates like any turnstile of the prior art. In the event of a robbery, after a store clerk actuates the system, a locking assembly comes into function in order to lock the trapping door (10). The locking assembly is comprised of a locking bar (24) that extends so as to interfere with a triangular member (26), which locks the turnstile member (12) from turning in one direction. To prevent the turnstile member (12) from turning in the opposite direction, a pair of ratcheting means (28, 28′) normally operate so as to also interfere with the triangular member (26). The ratcheting means (28, 28′) work in a fashion similar to ratchets of the prior art, meaning that they are movable when pushed in one particular direction but unmovable when pushed in any other directions. Biasing means (52), bring them back to their original position. The triangular member (26) ensures that their are only three positions in which the turstile member (12) can be locked in, and all positions have the same relative positioning of the door panels (14) which creates the cell (21) in which the robber is trapped.

The locking bar (24) is moved into its interfering configuration by way of a solenoid (30) and is brought back to its non interfering configuration by way of a pulling assembly comprised of a chain (32) which is pulled by a rotating cam (34) which rotates around an axis (36) so that a catch (38) can push it into rotation as the catch (38) itself is being moved by an officer of the law called by the shop owner. Only law officers can get the code to unlock the locking bar (24) by way of a dial (50) located under the tamper proof box (40) and always in zone “D” close to zone “A”. The robber is in cell (21) while the police officer arrive from the front door located in the area designated by letter “A”.

Alternatively, an electric lock can replace the solenoid. the rotating cam (34), and the catch (38) by simply using a rod (not shown) instead of the chain (32). The advantage is that the system by unlocking digital access control can be installed in the D section or at various locations outside the building or according to police request.

As is known in the art of turnstile doors, a means to slow down the rotation is sometimes employed. In this case, a spoked member (42) has its resiliently deformable spokes (44) hit a rigid peg (46) as a means to slow down and stop the turnstile from rotating under normal operating mode. Additional features include full plates (60) on the door panels (14) and the partition members (16) to facilitate pushing in the first instance and prevent children from putting their arms through the bars in the second instance. Various alloys and materials can be used for the bars such as stone or ceramic encased inside metal, etc. A motion detector (62) to ensure that there is someone inside the cell before locking it is an available option.

1. A robber trapping door comprising a turnstile member adapted to be securely mounted to a floor surface, and including a rotatable axis member having a vertical length and a plurality of door panels having equal heights and are attached along respective vertical side portions to said axis member along a substantial portion of said length of said axis member; a plurality of partition members adapted to be securely mounted to said floor surface having equal heights that are less than the length of said axis member and greater than the height of said plurality of door panels, wherein said plurality of partition members surround said turnstile member in a circular configuration having two openings on opposite sides thereof adapted for a person to pass therethrough; a top panel member securely fastened to a top portion of each said plurality of partition members, and including a passageway in a center portion thereof adapted to allow a top distal end of said axis member to pass therethrough, such that when said turnstile is rotated to a predetermined position, two of said plurality of door panels along with said partition members and said top panel member form an enclosed cell section adapted to trap a robber therein for apprehension; and a locking mechanism securely attached to a center top portion of said top panel member and mechanically connected to said top distal end of said axis member, and adapted such that a person can activate said locking mechanism, prevent the rotation of said turnstile member at said predetermined position, and lock it in place.)

2. The robber trapping door of claim 1, wherein one of said plurality of door panels includes a locked swing section adapted to be unlocked and opened creating an opening to thereby facilitate deliveries.)

3. The robber trapping door of claim 1, wherein said locking mechanism includes a tamper proof box covering said locking mechanism and is securely connected to said top panel member, thereby enclosing said locking mechanism and preventing unwarranted tampering of said locking mechanism.)

4. The robber trapping door of claim 1, wherein said locking mechanism is adapted to be operated remotely, such that a person can activate said locking mechanism from a distance to trap a robber, and then release said locking mechanism once a law enforcement officer arrives to apprehend said robber.)

5. The robber trapping door of claim 1, wherein said top distal end of said axis member includes a triangular shaped portion; and said locking mechanism includes a locking bar adapted to interfere with the rotational movement of said triangular shaped portion and thereby said turnstile.)

6. The robber trapping door of claim 5, wherein said locking mechanism further includes a solenoid member adapted to push said locking bar into an interfering position with said triangular shaped portion of said axis member; and a pulling assembly that includes a rotating cam that pulls a chain member, which pulls the locking bar away from said interfering position; and wherein said cam is rotated by a catch member that is adapted to be moved by person authorized to release said locking mechanism.

7. The robber trapping door of claim 6, wherein said catch member includes a dial member that only rotates when a predetermined code is entered and accepted therein.)

8. The robber trapping door of claim 6, wherein said locking mechanism further includes a pair of spring biased ratchet members adapted to also interfere with said triangular shaped portion, and adapted to unsure that said turnstile rotates in only one predetermined direction.)

9. The robber trapping door of claim 5, wherein said locking mechanism further includes an electric lock that is adapted to push said locking bar into an interfering position with said triangular shaped portion of said axis member, and adapted such that said locking mechanism can be operated remotely.)

10. The robber trapping door of claim 1, wherein said locking mechanism further includes a peg attached thereon; and said top distal end of said axis member further includes a spoked member having a plurality of resiliently deformable spokes radiating outwardly therefrom rotating along with said axis member and are adapted to hit said peg member and dampen the rotational movement of said turnstile.)

11. The robber trapping door of claim 1, wherein each of said plurality of door panels includes a plate member adapted to be pushed by a person passing through said turnstile.)

12. The robber trapping door of claim 1, further including at least one attachment bracket adapted to be attached between a partition member and said floor or an adjacent wall.

13. The robber trapping door of claim 1, further including a motion detector.)

14. The robber trapping door of claim 3, wherein said tamper proof box with all its locking systems is located at a time above and adjacent the cell and near an entrance to a building.)

15. The robber trapping door of claim 1, wherein an unlocking system, using combinations is always installed in a section adjacent said cell and proximal an entrance door.
